(19) United States
(12) Patent Application Publication
(10) Pub. No.: US 2012/0034348 A1
(43) Pub. Date: Feb. 9, 2012

(54) Pet food and method of preparation

(76) Inventor: Anthony L. Bennie, JR., Wilton, CT (US)

(21) Appl. No.: 12/806,018

(22) Filed: Aug. 4, 2010

(51) Int. Cl. A23K 1/10; A23K 1/18; A23K 1/14; A23K 1/16

(52) U.S. Cl. 426/92; 426/295

(57) ABSTRACT

A pet food product and method which utilizes meaty, whole, otherwise unaltered raw animal source ingredients which are coated, bonded and sealed with concentrated dried/dehydrated/and/or freeze dried vegetables, fruits, seeds, or other plant based nutrient powders, flakes, or other particle forms of dry shelf-stable vegetables or fruits. The raw animal-sourced ingredients could be the flesh or muscle meats, organ meats, or connective tissue from beef cattle, bison, elk, venison, lamb, mutton, other mammalian sources, or any form of poultry, or any fish or other marine protein ingredients. Sources could include, but would not be limited to liver, hearts, muscle meats, kidneys, tripe, spleen, lungs, and tendons, or any animal based protein source.

### FIELD OF THE INVENTION

The present invention relates to a pet food product and method of its preparation. The food utilizes plant based nutrient foods in combination with animal based products to create meaty, yet healthy pet treats.

### BACKGROUND OF THE INVENTION

It is well known and often too well accepted that most dogs, cats, ferrets, and other carnivorous pets will refuse to eat food or treats containing fruits, vegetables, seeds, nuts, or other organic, plant based foods, despite that fact that such nutrient sources should be a healthy part of a pet's diet. While certain pet foods consist of a combination of meat and vegetables ground into a homogeneous product, such food is usually not appetizing to the pet and is often rejected. As a practical matter, there currently are few, if any, pet food products which have been truly successful in providing nutritional plant based food components in pet foods or treats which are appealing enough to be consumed by most dogs, cats, and similar pets.

### SUMMARY OF THE INVENTION

It is thus the object of the present invention to provide a unique pet food treat which applies concentrated nutrient sources such as dehydrated vegetables, fruits, seeds, or other plant based nutrients to the surface of otherwise unaltered, natural meaty pet ingredient sources to create a new type of very nutritious pet treat, not previously found in the pet food and treats industry.

The pet food product and method of the present invention utilizes meaty, whole, otherwise unaltered raw animal source ingredients which are coated, bonded and sealed with concentrated dried/dehydrated/and/or freeze dried vegetables, fruits, seeds, or other plant based nutrient powders, flakes, or other particle forms of dry shelf-stable vegetables or fruits. The raw animal-sourced ingredients could be the flesh or muscle meats, organ meats, or connective tissue from beef cattle, bison, elk, venison, lamb, mutton, other mammalian sources, or any form of poultry, or any fish or other marine protein ingredients. Sources could include, but would not be limited to liver, hearts, muscle meats, kidneys, tripe, spleen, lungs, and tendons, or any animal based protein source.

The inventive method for preparing such pet food and treats is known as Phytonutrient Enrobing Technology (P.E.T.). This is a process which enhances the nutritional value of meat based food by adding the concentrated nutrients from fruits and vegetables. These organic plant-based nutrient compounds are called phytonutrients and they promote the health of animals as well as humans. Phytonutrients are not found in meat, while fruits, vegetables, nuts, seeds, legumes are all rich in phytonutrients. Although meat proteins and animal-based fats are the core of the carnivorous animal diet, nutritional research proves that the addition of the phytonutrients found in certain vegetables and/or fruits boosts the immune system and supports other cellular and overall bodily health and conditioning through the absorption of natural antioxidants and other nutrients. By adding these plant based nutrients as a surface coating (enrobing) to meaty foods, the animal ingests the beneficial nutrients from these sources without otherwise altering the natural state of the original source. By leaving the meat source intact and enrobing it with the concentrated dehydrated vegetables, fruits, seeds, or other plant based nutrients, rather than grinding and adding the vegetable or fruit ingredients, the texture, taste, chewing satisfaction, and dental benefits of the meaty treat are preserved.

Nutritional enhancement of the pet food of the present invention is derived from the unique method which creates a potent source of phytonutrients. Integral to the method is the dehydration of vegetables, fruits, seeds, or other plant based sources. The average level of moisture in fresh vegetables or fruits, as derived through nutritional analysis, is over 70% by weight. After the dehydration process, the non-nutritive moisture level of the flakes, powders, or equivalent particles made from dried/dehydrated/freeze-dried plant-based nutrients ranges from 10% to 25% by weight. Therefore, the dried/dehydrated/freeze-dried vegetables, etc. are, by definition and provable science, from 250% to 700% more concentrated in their nutrient density than their fresh, unaltered equivalents. In simple terms, one gram of the concentrated form of these ingredients has the same nutritional density as 2.5 to 7 grams of the unaltered equivalents.

Equally important to the method described herein is the concentration of the food product through oven roasting or other moisture reducing cooking processes. The additional step of oven roasting the animal/meat based ingredients after the enrobing process concentrates the phytonutrients in the finished food by taking the original moisture level of the animal/meat-based raw material and reducing it to approximately 25% of its original weight. For example, a pound of raw meat, organ meats, tendons, etc. will be cooked down to 0.25 lbs of the finished pet food material. Therefore, if 3% of the dried/dehydrated/freeze-dried vegetables, etc. are enrobed upon the raw meaty material before cooking, the presence in the finished cooked treat will be concentrated to a level of 12%, an increase of 400% nutrient density.

Thus the combination of the dehydration and oven roasting/moisture reducing processes enhances the presence of the phytonutrients to the equivalent of at minimum 30% of fresh vegetables or fruits through the dehydration and roasting methods combined. In this way, the treat delivers a highly potent phytonutrient supplement along with the meaty raw materials, yet it does not dilute the palatability or meaty flavor, texture, or nutritional benefits of the meat-based components.

The final food products have a distinct coating which bonds the dried plant based nutrients to the surface of the meaty base. This also visually and texturally distinguishes the treats prepared using the P.E.T. method from prior, conventional pet food and pet treats. In addition, the final products are shelf stable and need no refrigeration for packaging and retail sale. This is another advantage over the use of fresh vegetables which are perishable and which would prevent their convenient use in an animal food or treat.

The novel features which are considered as characteristic of the invention are set forth in particular in the appended claims. The invention, itself, however, both as to its design, construction and use, together with additional features and advantages thereof, are best understood upon review of the following detailed description with reference to the accompanying drawings.

### BRIEF DESCRIPTION OF THE DRAWINGS

FIG. 1 is a schematic representation of the steps of the method of the present invention.

### DETAILED DESCRIPTION OF THE INVENTION

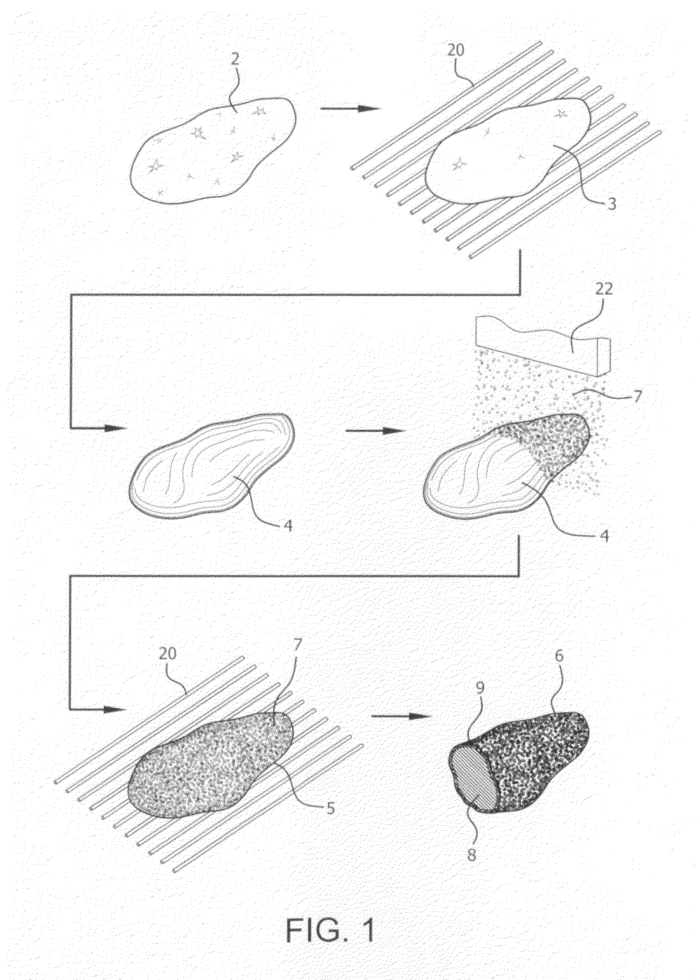

FIG. 1 illustrates an exemplar piece of raw meat prepared in accordance with the method of the present invention, which results in a unique pet food. Raw meat, organ meat, tendon, or other meaty raw material 2 is solidly frozen promptly after being harvested from the source animal to assure proper freshness and texture. Meat material 2 must remain frozen at all times prior to preparation. Frozen meat material 2 is then pre-conditioned in a cooler at between 33° and 40° Fahrenheit. Pre-conditioning time varies by raw material and cooler temperature. However, this time averages between 48 to 72 hours to reach desired consistency. Properly pre-conditioned meats will still be slightly frozen, but not completely thawed. It will have a firm texture and will be somewhat pliable.

In its thawed but slightly frozen state, meat 3 is then placed upon slotted baking racks 20 in a large, smoke truck-type oven. As a practical matter, large numbers of meat pieces are evenly distributed on the racks to ensure even roasting and thorough cooking on all surfaces and internally of the meat. Oven heat during this process should be at high enough temperatures to ensure that the meat pieces are cooked at levels above 165° Fahrenheit internally, so that they are free from bacteriological activity. The oven should remain at these temperatures for the next cooking stage of the process as well.

Meats are observed at regular intervals early during the oven roasting process until it is determined that the meats have cooked enough to reduce surface moisture from blood or natural juices to a level wherein there is no dripping of liquid from the baking racks. When this level of moisture elimination has been observed, meat 4 is removed from the oven.

A proprietary blend of dehydrated vegetables, fruits, seeds, and/or other nutrient-containing plant based food products 8 is uniformally mixed. While the percentage of this dehydrated mixture of plant based food may vary depending on the raw material meat selected, the average mixture is 3% of the weight of the pre-cooked meat.

Sifter 22 is used to evenly distribute the dehydrated mixture of plant based food 8 so that the right percentage is applied consistently to the surface of meats. The sifter is designed to have the proper sieve opening size which will allow the appropriate flow of the dehydrated mixture of plant based food. For instance, when applying the dehydrated mixture to flat raw meats such as liver, the dehydrated mixture is spread evenly on the top and bottom surfaces. When applying the dehydrated mixture to irregularly shape meats such as tendons, sliced hearts, kidney, spleen, and similar organs, the meats are manipulated manually to allow the dehydrated mixture to coat the meats of the more irregular surfaces.

The P.E.T. coated meat 5 is replaced on the baking racks in the hot oven as quickly as possible following coating, to begin the final process of enrobing the dehydrated mixture of plant based food 8 to the meat through heat sealing and bonding with the surface of the meat.

Once again, the coated meat 5 is cooked at temperatures consistent with the initial cooking stage. These temperatures will vary from 90° to 170° Fahrenheit, with variation and adjustment during the cooking process to prevent the coated meat from being cooked too quickly or heated excessively, which can cause overdrying, brittleness, or loss of palatability. Once again, however, internal temperature of the meaty source must reach 165° F. to ensure freedom from bacteriological pathogens. As a result, meats must be monitored and the internal temperatures of the meats taken periodically.

Average cooking time during this stage of the process will vary from 15 to 22 hours, depending on the meaty source material and ambient climate, e.g. thicker materials would require longer cooking time to reach proper cooking level and proper texture of final product. Cooking times will also vary according to temperature and humidity levels of the ambient atmosphere, with longer cooking times required in colder temperatures and shorter times in warmer temperatures, and more cooking time needed in areas of high humidity.

Final P.E.T. coated pet food product 6 will comprise a chewy or crunchy baked, meat core 8 depending on the meaty source material, and a visible coating 9 that will vary slightly in color and texture, depending on the blend of dehydrated vegetables, fruits, seeds, or other nutrient-containing plant foods chosen for the particular core meats. Thus, pet food 6 of the invention provides a nutritional, tasty, appetizing animal treat which utilizes fruits, vegetables, etc., with their attendant essential nutrients, combined with meat-based proteins and fats.

Multiple tests have been conducted to date on various raw meat materials, including beef liver, bison liver, and bison tendons. Prototype formulas have been successfully tested several times, resulting in a finished product which is shelf stable, highly palatable in taste tests with dogs, and providing a unique appearance not shared by any other dog food or treat.

Certain novel features and components of this invention are disclosed in detail in order to make the invention clear in at least one form thereof. However, it is to be clearly understood that the invention as disclosed is not necessarily limited to the exact form and details as disclosed, since it is apparent that various modifications and changes may be made without departing from the spirit of the invention.

1. A method of preparing enrobed pet food comprising the steps of:
providing a given quantity of fresh raw animal sourced meat;
freezing the meat into a solid frozen state;
partially thawing the frozen meat;
heating the partially thawed meat uniformally on all exterior surfaces and internally;
removing the meat from the heat when surface moisture of the meat is reduced;
providing an edible, organic phytonutrient containing plant based food;
dehydrating the phytonutrient food;
forming the dehydrated phytonutrient food into a disbursable, particle form;
distributing the dehydrated phytonutrient food particles evenly onto the surface of the heated meat;
coating the heated meat with the dehydrated phytonutrient food particles;
heating the dehydrated phytonutrient food particle covered meat uniformally on all exterior surfaces and internally;
sealing the phytonutrient particle food into the meat; and
producing an enrobed pet food having a baked on phytonutrient particle food substance coating bonded to the meat.

2. The method as in claim 1 further comprising the method of heating the meat both prior to and after coating at substantially the same temperature.

3. The method as in claim 1 wherein the organic phytonutrient containing food is a uniform blend of vegetables, fruits, seeds, or other organic plant based foods.

4. The method as in claim 1 wherein the organic phytonutrient containing food is substantially 3% of the weight of the quantity of meat.

5. The method as in claim 1 wherein the meat both prior to and after coating is heated to a temperature of at least 160° Fahrenheit.

6. The method as in claim 1 wherein the coated meat is heated for an average of twelve hours.

7. The method as in claim 1 wherein the raw meat comprises any animal based protein sourced meat product.

8. A pet enrobed food comprising:
an animal based protein sourced cooked meat; and
a coating circumscribing, sealed, and bonded to the meat, said coating comprising an edible, organic phytonutrient containing plant based food.

9. The pet enrobed food as in claim 8 wherein the organic phytonutrient containing food is a uniform blend of vegetables, fruits, seeds, or other organic plant based products.

10. The pet enrobed food as in claim 8 wherein the organic phytonutrient containing food is substantially 3% of the weight of the meat.

11. The pet enrobed food as in claim 8 wherein the meat comprises any animal based protein sourced meat product.
